(19) United States
(12) Patent Application Publication
(10) Pub. No.: US 2006/0119925 A1
(43) Pub. Date: Jun. 8, 2006

(54) Single torsional hinge mirror package

(76) Inventor: John W. Orcutt, Richardson, TX (US)

Correspondence Address: TEXAS INSTRUMENTS INCORPORATED, P O BOX 655474, M/S 3999, DALLAS, TX, 75265, US

(21) Appl. No.: 11/004,689

(22) Filed: Dec. 3, 2004

(51) Int. Cl. G02B 26/00

(52) U.S. Cl. 359/291

(57) ABSTRACT

The present invention provide an inexpensive combination package of a pivoting mirror support structure and drive mechanism suitable for use for devices requiring a scanning light beam such as laser printers and other display devices. By using a single axis torsional mirror, and a unitary plastic support structure for supporting the mirror and the electrical windings, a very simple and inexpensive mirror package can be manufactured.

### TECHNICAL FIELD

The present invention relates generally to the field of torsional hinge MEMS scanning engines and more particularly to methods and apparatus for providing an inexpensive combination of a pivoting mirror with a drive mechanism and support package.

### BACKGROUND

The use of rotating polygon scanning mirrors in laser printers to provide a beam sweep or scan of the image of a modulated light source across a photo-resistive medium such as a rotating drum is well known. More recently, there have been efforts to use a much less expensive flat mirror with a single reflective surface such as a mirror oscillating in resonance to provide the scanning beam. These scanning mirrors provide excellent performance at a very advantageous cost. Unfortunately, the resonant frequency of the mirror as it pivots about its torsional hinges is highly susceptible to stresses that cause tension or compression of the hinges. Robust mounting brackets are typically used to mount the torsional hinge mirrors to a using device. However, distortion of the bracket itself due to mounting stresses and/or different CTE (coefficient of thermal expansion) between a mirror and the bracket can produce sufficient stress in the mirror bracket that will cause the resonant frequency of the scanning mirror to change beyond acceptable limits or even destroy the mirror.

Therefore, a method or apparatus that reduces or substantially eliminates package stresses transmitted to the mirror hinge is needed.

Texas Instruments presently manufactures mirror MEMS devices fabricated out of a single piece of material (such as silicon, for example) typically having a thickness of about 100 to 115 microns using semiconductor manufacturing processes. The reflective surface of the mirror may have any suitable perimeter shape such as oval, elongated elliptical, rectangular, square or other. Single axis mirrors include the reflective surface portion and a pair of torsional hinges, which extend to a support frame or alternately the hinges may extend from the mirror portion itself to a pair of hinge anchors.

U.S. patent application Ser. No. 10/384,861 describes various techniques for creating the pivotal resonance of the mirror device about the torsional hinges. Thus, by designing the mirror hinges to resonate at a selected frequency, a scanning engine can be produced that provides a scanning beam sweep with only a small amount of energy required to maintain resonance. However, as will be appreciated, the resonant frequency of a pivotally oscillating device about torsional hinges will vary as a function of the stress loading along the axis of the hinges. For example, the Thermal Coefficient Expansion (CTE) difference between the MEMS type pivoting oscillating mirror made of silicon at its support package (made from a material other than silicon) causes fluctuations in hinge stress. Therefore, clamping the device in a package such that it is stressed in the hinged direction may cause significant stresses in the hinges as the temperature changes. These stress level changes result in changes to the resonant frequency of the pivotal oscillations beyond acceptable limits and/or can actually destroy the mirror.

Since applications that use a pattern of light beam scans, such as laser printers and imaging projectors, require a stable precise drive to maintain a constant scan velocity, the changes in the resonant frequency and scan velocity of a pivotally oscillating device due to temperature variations can restrict or even preclude the use of the device in laser printers.

Therefore, although the pivoting mirror itself is an extremely simple device and is robust once mounted in place and in an operating environment, the requirement of a heavy support bracket as used in the prior art for mounting the mirror to a using device and to protect and maintain alignment of the mirror substantially increases the overall weight and cost.

Therefore, it would be advantageous to provide an inexpensive and easily manufactured mirror package that is substantially unaffected by hinge stresses.

### SUMMARY OF THE INVENTION

These and other problems are generally solved or circumvented, and technical advantages are generally achieved, by preferred embodiments of the present invention, which provide an inexpensive mirror package made up of a pivoting mirror in a mirror support structure. The mirror device comprises a reflecting surface supported by a pair of torsional hinges. The pair of torsional hinges enables the reflecting surface of the mirror to pivotally oscillate around a selected axis.

More specifically, the pivoting mirror package comprises a unitary mirror support structure that includes a base portion for attaching the unitary mirror support structure to a using device such as a laser printer. The support structure further includes a mirror portion, which supports a pivoting mirror device over an aperture or open area in the mirror portion of the support structure. The structure further includes a bobbin portion formed below the open area supporting the mirror. The combination structure further includes a mirror device including an anchor member that attaches the mirror device to the unitary mirror support structure. The mirror device includes a mirror member having a reflecting surface and a back surface and at least one torsional hinge extending along a selected axis between the anchor and the mirror member for supporting the reflecting mirror member so as to allow pivoting about the selected axis. A permanent magnet is attached or otherwise bonded to the mirror member and a coil comprising a multiplicity of electrical windings on the bobbin portion of the unitary support structure is provided. The electrical windings are connected to an electrical source or current such that the multiplicity of windings will create a magnetic force that cooperates with the permanent magnet to pivot the mirror member about the selected axis on the at least one torsional hinge. The anchor member of the mirror device used to mount the device to the unitary support structure may be a single attaching pad for a one torsional hinged mirror, a pair of attaching pads for a two torsional hinged mirror, or a frame surrounding the mirror that may be attached to the reflecting and pivoting surface by either one or two torsional hinges.

According to one embodiment of the invention, the pivoting mirror may be a single sheet of silicon. However, it has been found advantageous to form a multilayered mirror device comprising not only a single layer mirror member, but also a hinge layer that is integral with the torsional hinge or hinges and which has a mirror side and a magnet side. The layer of material forming the mirror member has its back surface attached to the mirror side of the hinge layer, and the permanent magnet is bonded to the magnet side of the hinge layer. To help center the mass moment of the mirror device on the pivot axis, a spacer layer may be included between the mirror layer and the hinge layer. For many applications, it is also advantageous that the mirror device oscillate or pivot around its torsional hinge or hinges at a selected frequency, which selected frequency may advantageously be the resonant frequency of the device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a currently available combination support bracket, driving mechanism and torsional hinge mirror;

FIG. 2A is a top view of an example of a mirror suitable for use with the combination device of FIG. 1;

FIG. 2B illustrates a mirror image embodiment of the support bracket of FIG. 1 without the drive mechanism;

FIG. 2C illustrates the drive mechanism without the support bracket and also shows the position of the pivoting mirror;

FIG. 2D is similar to FIG. 2C, except the magnetic core pieces that actually drive the mirror have been removed;

FIG. 3 is a side view diagram illustrating the mirror with a magnet in place and the core pieces and the coils for driving the mirror combination package of FIG. 1;

FIG. 4 is a perspective view of the combination mirror and unitary support package of the present invention;

FIG. 5A illustrates the mirror of the present invention and the location and operation of a diametrically charged magnet;

FIG. 5B, 5C, 5D, and 5E are cross sectional views along section line 5B of the package of FIG. 4 of the present invention illustrating the interaction of the diametrically charged mirror and the windings on the coil bobbin according to different embodiments of the present invention; and

FIGS. 6A and 6B illustrate single hinged mirror embodiments suitable for use with the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

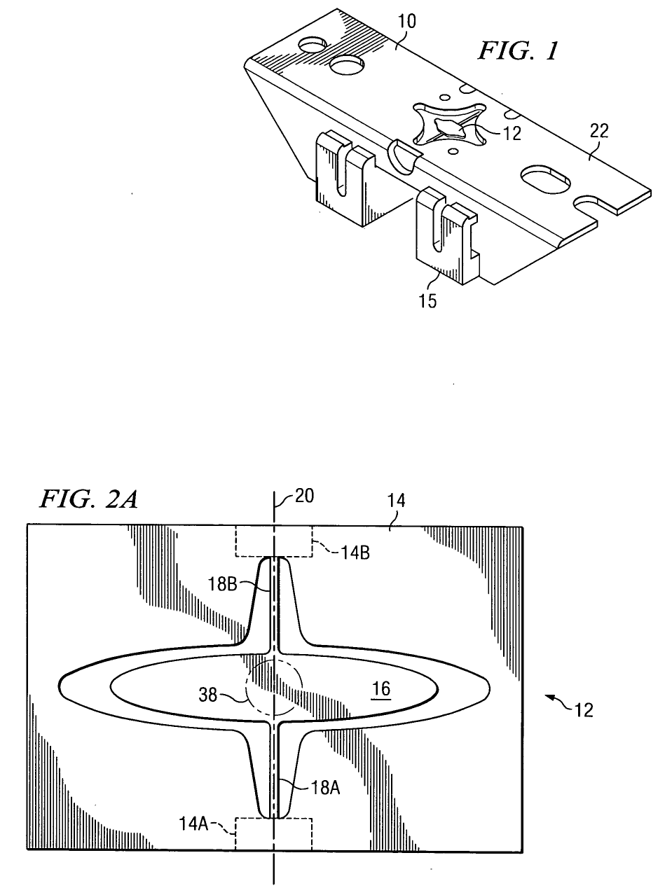

Referring now to FIG. 1, there is shown a presently available mirror package using torsional hinged mirrors. As shown, the combination package includes a support bracket 10, pivoting torsional hinged mirror device 12 and a drive mechanism (mostly obscured) 15.

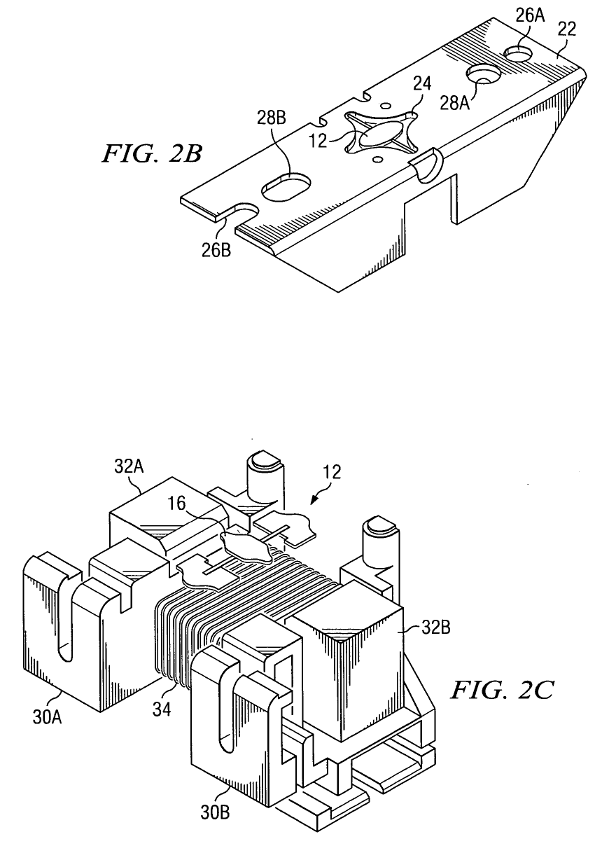

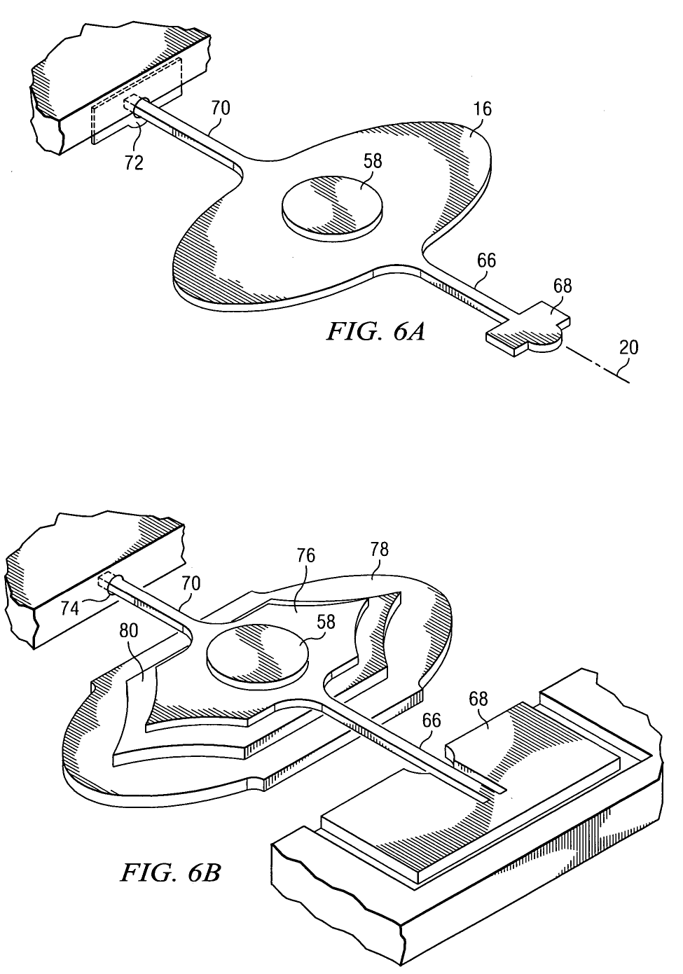

Various embodiments of torsional hinged mirrors may be used with the combination package illustrated in FIG. 1. However, FIG. 2A illustrates an example of a preferred long elliptical-shaped mirror for a using device such as a laser printer. As shown, the mirror device 12 will include an anchor such as frame 14 and a surface for reflecting light such as mirror member 16. Mirror member 16 is supported by a pair of torsional hinges 18a and 18b extending from the mirror to the anchor member 14. In the embodiment shown in FIG. 2A, the anchor member is frame 14. However, it will be appreciated that instead of a complete frame around mirror member 16, the anchor 14 may simply include a pair of anchor pads 14a and 14b shown in dotted line. Thus, a drive mechanism applies forces to the mirror member 16, so that the mirror member 16 will pivot or oscillate (preferably at a resonant frequency) about the torsional hinges 18a and 18b. The pivot axis or selected axis 20 lies along the torsional hinges 18a and 18b. In the embodiment shown, the frame member 14 or the anchor pads 14a and 14b are mounted to the under surface of plate 22 of support bracket 10. In the illustrative embodiment, the mirror device 12 is formed from a single slice of silicon. However, it will be appreciated that the mirror device 12 could also be a multilayered structure having a mirror layer and a hinge layer, such as illustrated in FIG. 6B to be discussed hereinafter. A spacer layer could also be included to help center the mass moment of the mirror device 12 on the pivot axis.

Referring to FIG. 2B, there is an alternate view (mirror image) of the support bracket shown in FIG. 1 unencumbered by the drive mechanism or the mirror. As illustrated, the support bracket includes a first mirror attaching aperture 24 over which the mirror is attached, a pair of locating or alignment apertures 26a and 26b, which received locator pins (not shown), and a pair of apertures 28a and 28b, which receive bolts for mounting the structure to a using device.

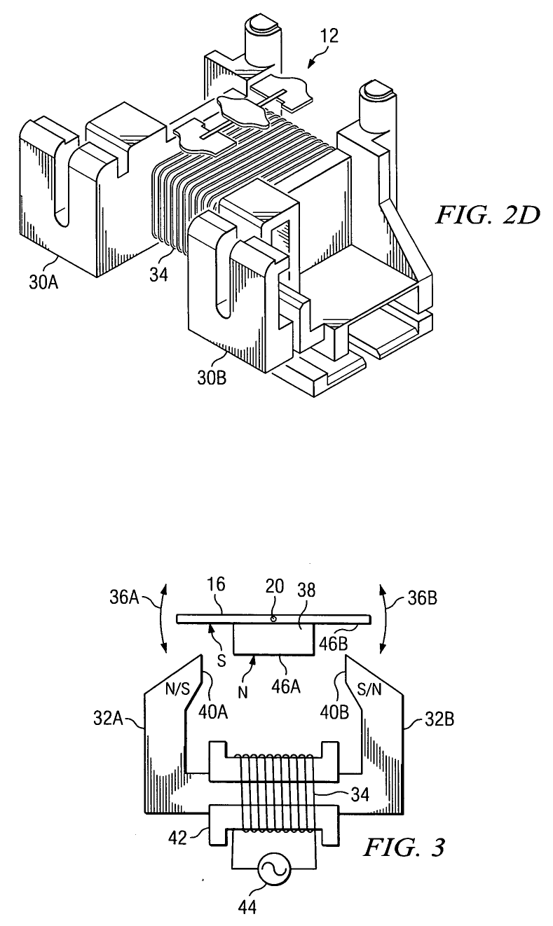

Referring to FIG. 2C, there is shown a drive mechanism with the mirror illustrated in the location it would occupy if mounted to the bracket of FIG. 1 or FIG. 2B. The drive mechanism includes mounting portions 30a and 30b, core pieces 32a and 32b for pivoting the mirror or reflecting surface 16 of mirror device 12. The interaction of a permanent magnet mounted on mirror device 12 and the drive mechanism of FIG. 2C will be discussed hereinafter with respect to FIG. 3.

FIG. 2D is similar to the illustration of FIG. 2C except the core members 32a and 32b have been removed.

Referring now to FIG. 3, there is shown a cross sectional view of the drive mechanism illustrated in FIG. 2C. Elements of FIG. 3 that are the same as the elements of FIG. 2C carry the same reference numbers. Therefore, as shown, the pivoting mirror member 16 is supported along its pivoting or selected axis 20 by torsional hinges not shown. Thus, the mirror is free to pivot about the selected axis 20 as indicated by arcuate arrows 36a and 36b. Also as shown, the mirror member 16 of mirror device 12 includes an axial charged permanent magnet 38 mounted with its north/south pole or axis perpendicular to the surface of the mirror member 16. Also shown are the core pieces 32a and 32b, which extend to end points 40a and 40b. A conductive wire is wound around the core pieces 32a and 32b to provide a multiplicity of windings 34. The two ends of the wire wound around a plastic bobbin 42 and the core pieces are connected to an alternating power source 44 for providing an alternating current through the windings 34. Thus, it will be appreciated that the core ends 40a and 40b will continually change between a north pole and a south pole. The coils or windings are also wound such that when pole 40a is positive (north), pole 40b is negative (south), and when pole 40b is north, 40a is south. Thus, when pole 40a has a south orientation, the north pole 46a of permanent magnet 38 will be attracted to pole 40a while at the same time the north pole orientation of 40b will repel north pole 46a of the permanent magnet and attract south pole 46b. Then, as will be appreciated by those skilled in the art, when pole 40a has a north orientation and pole 40b has a south orientation, the magnet 38 and mirror member 16 will pivot in the opposite direction. Further, as will be appreciated, the mirror member 16 of the mirror device 12 will preferably have a resonant frequency about the selected axis and if the alternating current supplied by power source 44 is set to pivot the mirror member 16 at this resonant frequency, the mirror will pivotally oscillate at the resonant frequency with a minimum amount of power being used.

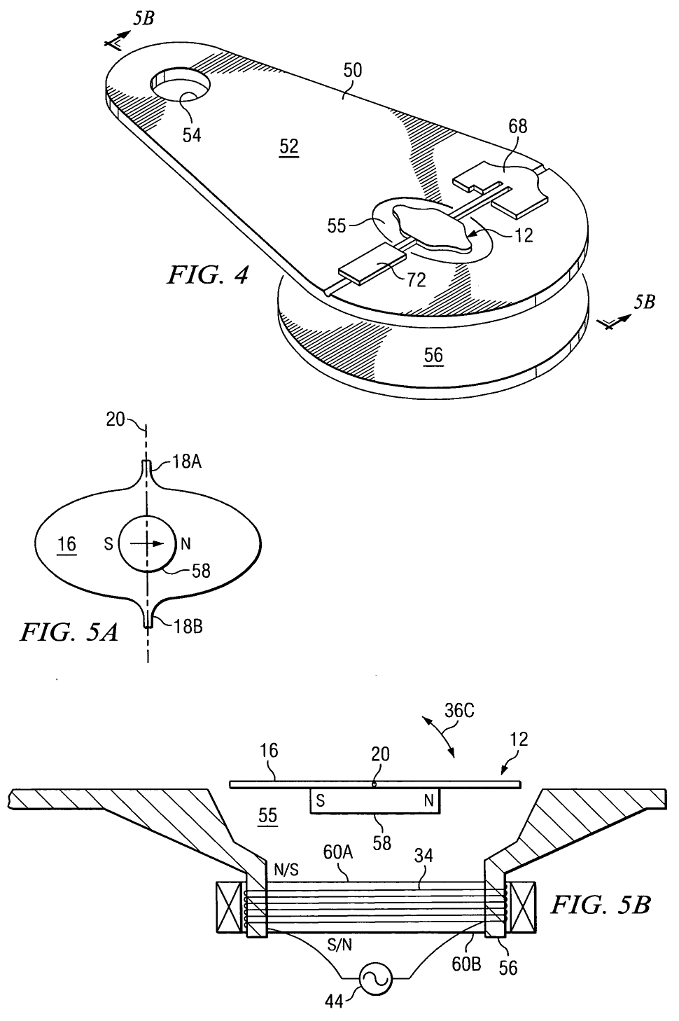

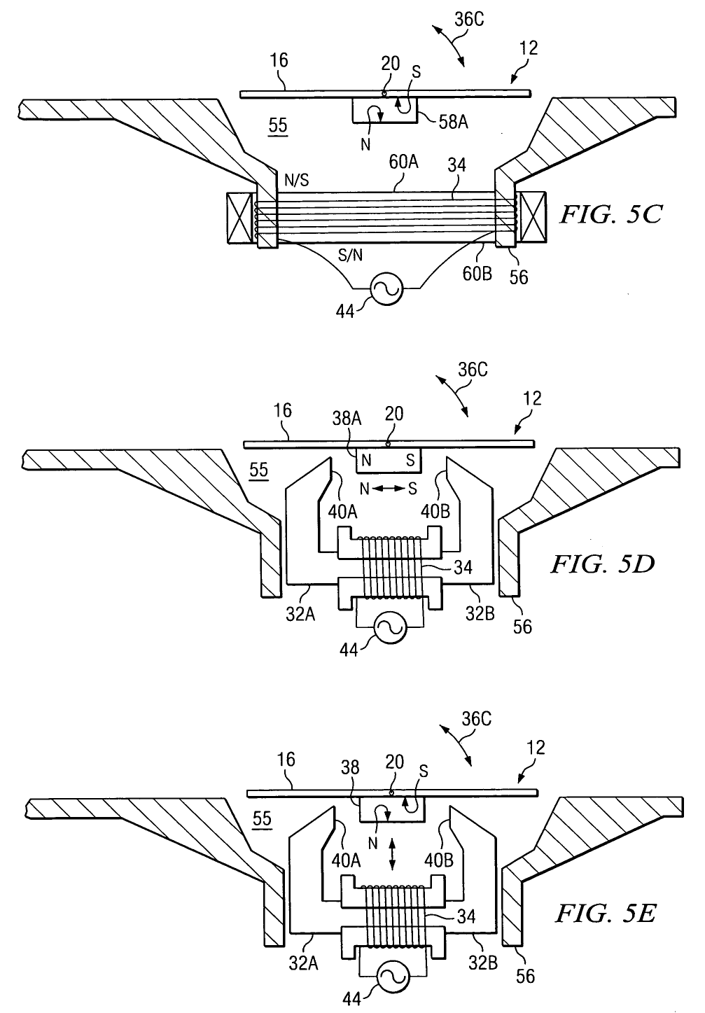

Referring now to FIG. 4, there is shown the package combination of mirror device 12 and support structure of the present invention. As shown, the unitary mirror support structure 50 is made of a sturdy material such as for example, a high impact and/or injection molded plastic and includes a mounting area 52 defining a mounting hole 54 for mounting the structure to a using device such as for example, a laser printer. Materials other than high impact plastic, such as for example a machined block of metal, could of course be used. The top of the unitary structure further includes a mirror area for supporting the mirror device 12 and defines an aperture such that the mirror member 16 of the mirror device 12 can freely pivot about its axis and about its torsional hinges. Below the mirror device 12 and integral with the support structure, there is included a bobbin portion 56 for supporting the electrical windings 34. The windings 34 may operate as an air core magnet in which case there are no core pieces necessary as was used with respect to FIG. 2C and FIG. 3. Also, as is illustrated in FIGS. 5A and 5B, the magnet 58 on the back side of the mirror member 16 is diametrically charged rather than axially charged as in the package discussed with respect to FIG. 1.

Referring now to FIG. 5A, there is a partial view of the back surface of the mirror member 16 of the mirror device 12 and the location of the torsional hinges 18a and 18b. Also shown is a picture of the diametrically charged magnet 58 showing a north pole/south pole orientation that is perpendicular to the pivoting axis 20.

Now referring to FIG. 5B, there is shown a cross sectional view of FIG. 4 along line 5b-5b. As was discussed, mirror device 12 is mounted above the mirror aperture 55 in the unitary support structure such that the mirror member 16 of the mirror device 12 may freely rotate around axis 20 as indicated by arcuate arrow 36c. The electrical conductor 534 wound around the bobbin portion 56 of the unitary structure 50, is wrapped such that when an alternating power supply 44 is connected to the two ends of the wiring creating the windings, the magnetic forces created by the windings will result in a north pole/south pole orientation that is perpendicular to the plane of the mirror (when the mirror is in its neutral position) and the north pole/south pole alternates such that the top side 60a of the bobbin portion 56 switches between a north and south orientation as does the bottom side 60b. Thus, as shown in the illustration, when the top side 60a of the coil structure has a north pole orientation, the north orientation of the permanent magnet will be repelled and the south pole of the permanent magnet will be attracted. However, since the north pole and south pole of the permanent magnet are on opposite sides of the axis, the mirror will pivot under these magnetic forces. When the orientation of the electromagnet is switched by the alternating current, the forces will reverse and the mirror will pivot in the opposite direction. Thus, if the current alternates at the resonant frequency of the mirror, the mirror will resonate and continue to pivotally oscillate with minimal power. It should also be appreciated that, although a diametrically oriented poles may be preferable for use with the unitary structure 50 shown in FIG. 5B, an axial charged permanent magnet may also be used as shown in FIG. 5C. Although the magnetic forces between the permanent magnet 58A and the electromagnetic coils 34 on each side of the pivot 20 of FIG. 5C are substantially balanced when the mirror is in its neutral (i.e. no rotation) position, if the mirror is even slightly rotated the magnetic forces would not be equal and the magnetic forces would cause even further rotation. The greater the rotation, the greater the imbalance of forces on each side of the pivot point. Consequently once rotation starts, the mirror should achieve oscillations at the resonant frequency.

Referring now to FIGS. 5D and 5E, there is shown a structure similar to that discussed with respect to FIG. 5B that incorporates the electromagnetic structure illustrated and discussed with respect to FIG. 3. FIG. 5D, however, unlike FIG. 3 illustrated with diametrically oriented poles 38a, whereas FIG. 5E was an axially charged permanent magnet 38 in its same manner as discussed with respect to FIG. 3.

In addition to a two hinged torsional mirror as has been discussed, the combination structure of the present invention may also be advantageously operated with a single hinge torsional mirror. As will be appreciated, a two hinged mirror may be subjected to outside conditions, such as for example, temperature changes that create stresses of compression or tension on the hinges. These stresses may change the resonant frequency of the mirror. Therefore, referring to FIGS. 6A and 6B, there are illustrated bottom views of two different embodiments of a mirror device comprising a single torsional hinge 66 having a mounting pad 68 that is bonded to the unitary support structure. An axial member 70 may be included on the mirror device along the axis 20 at the side opposite the hinge. The axial member 70 is not mounted to the support structure and does not include an anchor member. A hub member 72 may be provided as a support for the axial member 70 to allow free rotation of the axial member while preventing movement in the plane perpendicular to the pivoting axis as shown in the single layer embodiment of FIG. 6A. Alternately, the axial support may simply comprise an aperture 74 defined in the support structure as shown in the layered structure of FIG. 6B. The single axis layered structure mirror device of FIG. 6B includes a hinge layer 76 integrally formed with the torsional hinge 66 and axial member 70 and a mirror layer 78. The permanent magnet 58 is bonded to the back or magnet side of the hinge layer and the mirror layer 78 is attached to the front side of the hinge layer 66. The embodiment of FIG. 6B further includes a spacer portion 80 located between the mirror layer 78 and the hinge layer 76. The spacer portion 80 may be completely separated from the mirror layer 78, or the mirror layer 78 and spacer portion 80 may preferably be a single integral structure that could, for example, be etched from a single piece of silicon. On the other hand, when the combination thickness of the mirror layer 78 and spacer portion 80 is one the order of 240 microns (about 72 microns for mirror layer 78 and 168 microns for spacer portion 80), mirror layer 78 and spacer portion 80 may be formed as separate layers that are then bonded together. However, even for the thicker mirror structure it may still be preferable to etch the mirror layer 78 and spacer portion 80 as an integral structure from a single piece of silicon. It should also be understood that the spacer portion could even be omitted in some embodiments so long as the mirror layer is selected with a weight/mass and a thickness such that the mass moment of the entire structure can be located or centered on the pivot axis.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A pivoting mirror package comprising:
a unitary mirror support structure defining a base portion for attaching said unitary mirror support structure to a using device, a mirror portion for supporting a mirror device over an open area in said mirror portion, and a bobbin portion formed below said open area;
a mirror device including an anchor member for attaching said mirror device to said unitary mirror support structure, a mirror member having a reflecting surface and a back surface, and a first torsional hinge extending along a selected axis between said anchor member and said mirror member for supporting said mirror member to pivot about said selected axis;
a permanent magnet attached to said mirror member; and
a coil comprising a multiplicity of electrical windings proximate said bobbin portion of said unitary mirror support structure such that an electrical current in said multiplicity of windings will create a magnetic force that cooperates with said permanent magnet to pivot said mirror member about said torsional hinge.

2. The pivoting mirror package of claim 1 wherein said anchor member is a first attaching pad and said mirror device including a second attaching pad and another torsional hinge extending away from said first torsional hinge and along said selected axis between said mirror member and said second attaching pad.

3. The pivoting mirror package of claim 1 wherein said anchor member is a frame and said mirror device includes another torsional hinge extending away from said first torsional hinge and along said selected axis between said mirror member and said frame.

4. The mirror package of claim 1 wherein said mirror device further comprises an axial member having a first end attached to said mirror member and a free end, said free end extending away from said mirror member along said selected axis, and said mirror package further comprising an axial support for receiving said free end of said axial member, said axial support constraining movement of said axial member in a plane perpendicular to said selected axis while allowing said free end of said axial member to rotate about said selected axis.

5. The pivoting mirror package of claim 4 wherein said axial support comprises a hub portion on said unitary mirror support, said hub portion defining an aperture for receiving said free end of said axial member.

6. The pivoting mirror package of claim 4 wherein said axial support comprises a hub member secured to said unitary mirror support structure, said hub member defining a recess for receiving said free end of said axial member.

7. The pivoting mirror package of claim 1 wherein said mirror device further comprises a hinge layer integral with said first torsional hinge and having a mirror side and a magnetic side and a mirror layer of material having its back surface attached to said mirror side of said hinge layer, said permanent magnet attached to said magnet side of said hinge layer.

8. The pivoting mirror package of claim 7 wherein said torsional hinge is made of silicon.

9. The pivoting mirror package of claim 7 further comprising a spacer portion between said hinge layer and said mirror layer.

10. The pivoting mirror package of claim 9 wherein said mirror layer is silicon.

11. The pivoting mirror package of claim 9 wherein said mirror layer and said spacer portion are an integral structure formed from a single piece of material.

12. The pivoting mirror package of claim 9 wherein said mirror layer and said spacer portion are formed from separate pieces of material.

13. The pivoting mirror package of claim 11 wherein said mirror layer and spacer portion integral structure are etched from a single piece of silicon.

14. The pivoting mirror package of claim 7 wherein the thickness and mass of said spacer portion is selected such that the mass moment of said permanent magnet and the mass moment of said mirror device is balanced on said selected axis.

15. The pivoting mirror package of claim 1 wherein said mirror device oscillates on said torsional hinge around said selected axis at a selected frequency.

16. The pivoting mirror package of claim 15 wherein said selected frequency is the resonant frequency of said mirror device that about said torsional hinge.

17. The pivoting mirror package of claim 1 wherein said unitary mirror support structure is made of plastic.

18. The pivoting mirror package of claim 17 wherein said mirror support structure is high impact injection molded plastic.

19. The pivoting mirror package of claim 1 wherein said unitary mirror support structure is a machined block of material.

20. The pivoting mirror package of claim 1 further comprising a core piece and wherein said multiplicity of electrical windings are around said core piece such that said core piece provides a magnetic force that cooperates with said permanent magnet to pivotally oscillate said mirror.

21. The pivoting mirror package of claim 20 wherein said permanent magnet is diametrically charged.

22. The pivoting mirror package of claim 20 wherein said permanent magnet is axially charged.
